(19) United States
(12) Patent Application Publication
(10) Pub. No.: US 2026/0322222 A1
(43) Pub. Date: Oct. 15, 2026

(54) LANDSCAPING TOOL PROVIDED WITH AN ELECTRIC BATTERY AND ELECTRICAL CONNECTOR FOR SAID TOOL

(71) Applicant: EMAK S.P.A., BAGNOLO IN PIANO (IT)

(72) Inventor: Gianluca BARBOLINI, MODENA (IT)

(21) Appl. No.: 19/485,414

(22) PCT Filed: Apr. 19, 2024
(86) PCT No.: PCT/IB2024/053824

§ 371 Date: Nov. 18, 2025

(30) Foreign Application Priority Data
Jun. 28, 2023 (IT) 102023000013380

(51) Int. Cl. H02K 11/35; B25F 5/00; H02K 5/22; H02K 7/14; H02K 11/00

(52) U.S. Cl. CPC H02K 11/35; H02K 5/225; H02K 7/145; H02K 11/0094; B25F 5/00; H02K 2211/03

(57) ABSTRACT

A battery-operated electric landscaping tool (1) is described, comprising: an electric motor (M), a power supply battery (20) of the electric motor, which power supply battery is provided with an electronic board (21) configured to allow the monitoring of at least one value of an operating parameter of the power supply battery and/or in which a value of an operating parameter of the power supply battery is stored and/or an identification code of the battery is stored, said electronic board being configured to communicate said value, or said values, and/or said identification code, according to a first communication protocol, an electronic control and command unit (55) of the electric motor (M) operatively connected to the electric motor and the battery, and configured to regulate the electric power supply of the electric motor also based on the value of the operating parameter of the power supply battery and/or the identification code, said electronic control and command unit of the motor being configured according to a second communication protocol which is different from the first communication protocol, and an electrical connector (60,60′) galvanically interposed between the electronic control and command unit of the motor and the power supply battery, and to which a battery connection interface is connected. The connector comprises an electronic control and command unit (65), which is galvanically connected to the electronic control and command unit (55) of the motor, and an electronic memory (70), which is galvanically connected to the electronic control and command unit (65) of the connector. Where a computer code is stored in the electronic memory, which when executed by the electronic control and command unit translates signals in the first communication protocol received from the electronic board of the battery, into signals in the second communication protocol and sends them to the electronic control and command unit of the motor.

### TECHNICAL FIELD

The present invention relates to a landscaping apparatus provided with a landscaping tool, such as chainsaws, brush cutters, hedge trimmers, blowers, lawn mowers, etc.

### PRIOR ART

Landscaping tools with batteries, i.e., powered by means of an electric battery, generally comprise an electric motor, adapted to drive a working element, and an electronic control and command unit operationally connected to the electric motor and configured to regulate the electrical power supply of the motor. In particular, the electronic control and command unit is configured to regulate the frequency and intensity of a power supply current which has the battery as its source.

The battery and the electronic control and command unit communicate with each other by means of the same communication protocol, in particular the battery communicates to the electronic control and command unit the values of parameters measured by a control unit in the battery itself and based on which the electronic control and command unit can vary the regulation of the electrical power supply of the motor.

The standardisation of batteries is an aspect which is becoming increasingly important, both in the light of the convenience for the customer of having one type of battery for use on several tools, and in the light of battery price reductions due to economies of scale.

One problem posed by such a market trend lies in the fact that, as described above, manufacturers generally make tools with an electronic control and command unit which communicates by means of a communication protocol shared with the battery and which is specific from manufacturer to manufacturer, or even from model to model. Therefore, a tool remains limited to the use of the battery for which it was designed, not only in consideration of size, or connection, but precisely because of the impossibility of communication between a possible new battery and the pre-existing control unit which had been configured to communicate with a different type of battery, i.e., with a different communication protocol.

### DISCLOSURE OF THE INVENTION

An object of the present invention is to overcome the constraints of the prior art in the context of a rational and efficient solution with limited costs.

This and other objects are reached thanks to the characteristics of the invention as reported in the independent claims. The dependent claims outline preferred and/or particularly advantageous aspects of the invention which however are not strictly required for the implementation thereof. particular, the invention provides a battery-powered electric landscaping (gardening) tool, comprising:
an electric motor,
a power supply battery (20) of the electric motor, which power supply battery is provided with an electronic board (21) configured to allow the monitoring of at least one value of an operating parameter of the power supply battery and/or in which a value of an operating parameter of the power supply battery is stored and/or a preset identification code of the battery is stored, said electronic board being configured to communicate said value, or said values, and/or said preset identification code, according to a first communication protocol,
an electronic control and command unit (55) of the electric motor (M) operatively connected to the electric motor and to the battery, and configured to regulate the electrical power supply of the electric motor also based on the value of the operating parameter of the power supply battery, or based on the value of the monitored operating parameter and the value of the stored operating parameter, and/or the preset identification code, said electronic control and command unit of the motor being configured according to a second communication protocol which is different from the first communication protocol,
an electrical connector galvanically interposed between the electronic control and command unit of the motor and the power supply battery, and to which a connection interface of the battery is connected which the connector comprises an electronic control and command unit, which is galvanically connected to the electronic control and command unit of the motor, and an electronic memory, which is galvanically connected to the electronic control and command unit of the connector itself, which a computer code is stored in the electronic memory, which, when executed by the electronic control and command unit, translates signals in the first communication protocol received from the electronic board of the battery, into signals in the second communication protocol and sends them to the electronic control and command unit of the motor.

Thanks to such a solution, it is possible to make a tool that was designed for a different battery, thus designed to communicate according to a different communication protocol, compatible with a predefined type of batteries, and thus designed to communicate according to a different communication protocol, thus solving the above-mentioned drawbacks of the known art. The proposed solution to make pre-existing tools, e.g., of different types and manufacturers, e.g., all with different communication protocols, compatible with a different type of battery, e.g., a single type of battery, is particularly efficient and economical, as replacing the connector of the original tool is not demanding for the production chain and is extremely cost-effective, in particular cheaper than redesigning according to a different communication protocol and replacing the electronic control and command unit controlling the motor. The only need will be to calibrate the computer code based on the different communication protocols, so that it executes the translation/conversion of the signals.

According to an aspect of the invention, the connector may comprise a wireless transceiver.

It is thereby possible to add remote control and/or management functionalities to a tool which was not initially designed with such an this idea, in a simple manner and without acting on the original electronic control and command unit.

According to another aspect of the invention, the tool may comprise a housing compartment for the power supply battery, and the connector in such a case is positioned at such a housing compartment

According to yet another aspect of the invention, the stored operating parameter of the battery can be the maximum power deliverable, i.e., the maximum discharge value. In such a case, the electronic control and command unit of the motor can be configured to limit the maximum power of the motor based on the stored value of said operating parameter (i.e., based on the signal containing the value of the operating parameter according to the second communication protocol, obtained from the conversion/translation of the signal containing such a value according to the first communication protocol).

It is thereby possible to avoid overheating of the battery, which can occur when connecting it to a motor which is excessively powerful for the features of the battery itself. The invention can further provide that the connector may comprise a connection interface by means of which it is galvanically connected to the battery, which connection interface comprises at least one electrical contact which is galvanically connected to the electronic board of the battery (i.e., to an electrical contact of a connection interface of the battery). According to another aspect of the invention, the electronic control and command unit of the motor can be configured not to electrically power the motor if the battery identification code is different from a preset identification code, or from a preset group of identification codes, stored in the electronic control and command unit of the motor.

This thereby increases the safety of use, as only authorised batteries may be used.

The invention also provides an electrical connector for a battery-powered landscaping (gardening) tool, said electrical connector comprising:
a first connection interface adapted to allow a removable galvanic (and mechanical) connection to a power supply battery of the landscaping tool,
an electrical cable, or a second connection interface, adapted to allow a galvanic connection to an electronic control and command unit of the landscaping tool
an electronic control and command unit galvanically connected to the first interface and to the second interface or to the electrical cable, and
an electronic memory, which is galvanically connected to the electronic control and command unit of the connector itself, in which a computer code is stored in the electronic memory, which, when executed by the electronic control and command unit, translates signals received by means of the first communication interface (i.e., which cross the first communication interface) and encoded according to a first communication protocol, into corresponding signals encoded in a second different communication protocol and sends them to the electronic control and command unit of the motor after such a translation/conversion.

According to an aspect of the invention, the connector may comprise a box-like enclosure (watertight, air-tight) provided with the first connection interface and the second connection interface, positioned so as to be accessible from outside the box-like body itself, and in which the electronic control and command unit is positioned inside the box-like body.

### BRIEF DESCRIPTION OF THE DRAWINGS

Further features and advantages of the invention will be more apparent after reading the following description provided by way of non-limiting example, with the aid of the accompanying drawings.

FIG. 1 is a schematic side view of a landscaping tool according to the invention.

FIG. 2 is a flow chart of a portion of the tool of FIG. 1 according to a first embodiment of the invention.

FIG. 3 is a flow chart of a portion of the tool of FIG. 1 according to a second embodiment of the invention.

FIG. 4 is a schematic side view of an electrical connector according to the first embodiment.

FIG. 5 is a schematic side view of an electrical connector according to the second embodiment.

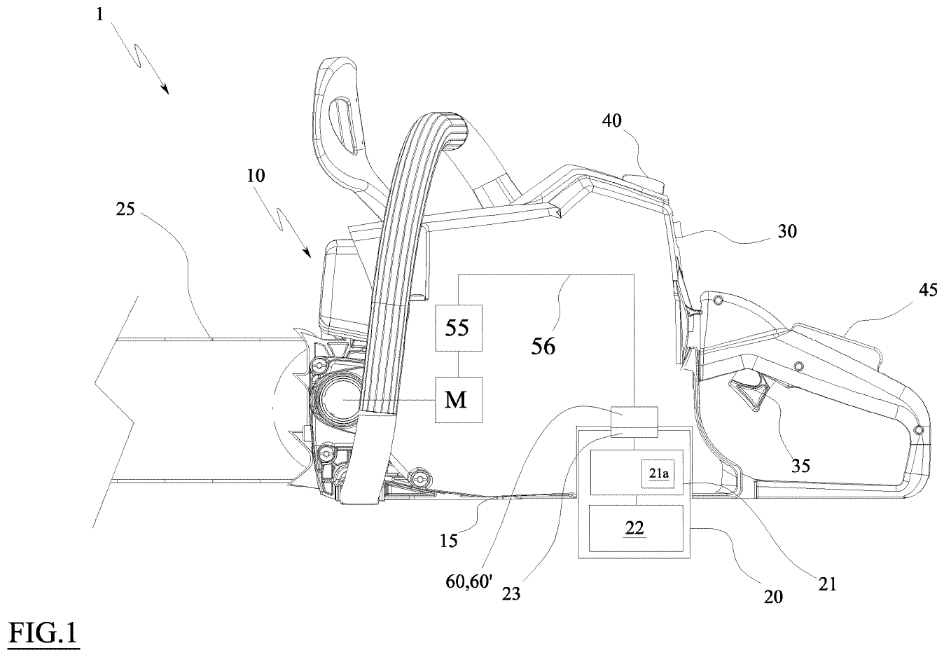

### DETAILED DESCRIPTION OF THE INVENTION

With particular reference to such figures, a landscaping tool, such as a chainsaw, brush cutter, pruner, grass trimmer, shredder, walking tractor (motor cultivator, scarifier, etc.), hedge trimmer, atomiser or blower, has been referred to as 1.

For illustrative purposes only, a chainsaw is shown in the figures.

The tool comprises a (rigid) casing 15, e.g., box-like, adapted to protect, e.g., by containing therein, portions or all of the components of the tool itself, such as the motor, frame, electrical circuits and electrical and/or electronic wiring. The casing can be composed of a plurality of elements, i.e., there can be a plurality of casings, e.g., box-like, based on the type of tool. The casing is preferably made of polymer material, however, it is not excluded that it may be made of metal or comprise metal portions.

The tool may comprise a support frame (not illustrated in the figures), which gives the tool structural rigidity and allows at least part of the tool's components to be fixed thereto. It is not excluded out that the casing may itself be part of, or the entire, supporting frame.

The tool may comprise a motor M, e.g., an electric motor.

The motor is in particular a drive motor for a movable working element of the tool itself (an element that enables to carry out a job for which the tool is designed). Such a movable working element may be a movable cutting element 25, such as a chain with sharp teeth (illustrated in the figures), or a rotating wire or a plurality of parallel sharp teeth or rotating knives, or an impeller or a fan adapted to pressurise a fluid (usually air).

The motor and the movable working element are for example fixed to the tool itself.

The motor M is powered by an electric power supply battery 20, e.g., removably associated with the tool, i.e., to the tool casing and/or frame, in particular the battery may be contained within a box-like enclosure which is removably associated, e.g., by quick release means, to the tool, i.e., to the tool casing and/or frame.

Regardless of whether the electric power supply battery 20 is removable or not, it comprises an electronic board 21, e.g., at least configured to allow the data communication from the battery to the tool.

In detail, the electronic board 21 is configured to allow the monitoring of at least one value of an operating parameter of the power supply battery.

Alternatively or additionally, a (preset) value of an operating parameter of the power supply battery is stored in the electronic board 21, i.e., in an electronic memory 21a of the electronic board itself.

Alternatively or additionally, a preset battery identification code is stored in the electronic board 21, i.e., in an electronic memory 21a of the electronic board itself.

Such a preset identification code stored in the battery may contain at least one among a serial number, an identification code of one or more predetermined manufacturers, and an identification code of the battery technology.

The measured operating parameter can for example be at least one among a battery voltage and its temperature.

The stored operating parameter may, for example, be related to battery type and performance, and is established and provided by the battery manufacturer. Preferably such a stored operating parameter is the maximum power deliverable by the battery, i.e., the maximum discharge value of the battery, which is measured in Watts.

In an embodiment, the electronic board does not perform monitoring and comprises the electronic memory provided with the value of the operating parameter of the power supply battery, which operating parameter is preferably the maximum power deliverable by the battery, i.e., the maximum discharge value of the battery. Alternatively, in another preferred embodiment, the electronic memory may comprise only the preset identification code.

The electronic board 21 is configured according to a first communication protocol. In other words, the electronic board 21 is configured to generate and send and/or to receive and process, (electronic and/or digital) signals encoded according to a first communication protocol.

The value, or values, of the operating parameter stored in the electronic memory of the electronic board, and the preset identification code if present, are encoded according to the first communication protocol, in other words they are written according to a first communication language.

The monitoring and sending of the values monitored/measured by the electronic board also occurs according to the first communication protocol.

The battery 20 may comprise a plurality of electrical cells 22 (connected to each other in series and/or parallel to obtain a chosen voltage and amperage in output from the battery), e.g., contained in the box-like enclosure, galvanically connected to said electronic board 21.

Furthermore, the battery 20 may comprise an (electrical or electronic) connection interface 23, adapted to allow an electrical or electronic connection with the tool. The connection interface 23 is galvanically connected to the plurality of electrical cells 22 and to the electronic board 21, e.g., it is positioned on the box-like enclosure so as to be reachable from outside the box-like enclosure itself (in other words, the connection interface 23 crosses a wall of the box-like enclosure).

The connection interface 23 is configured to allow an electrical (and mechanical) connection to a corresponding connection interface and may, for example, comprise a plurality of electrical contacts and a guide body (adapted to act as a guide for a complementary engagement body), and possibly a coupling body (for the removable connection).

The connection interface 23 is substantially shaped like an electrical/electronic connector. It should be specified that connector is intended as a portion of a plug and socket engagement (in other words plug-n-play), i.e., an engagement which allows electrical cables and/or electronic boards, electronic control and command units to be directly fixed to each other. In detail, the connector comprises the guide body and the electrical contacts for the connection.

There may for example be two electrical contacts of the plurality of electrical contacts of the connection interface 23 for transferring electrical energy, two for measuring battery temperature, one for grounding and one for transferring the measured operating parameter value and/or the stored operating parameter value and/or the preset identification code (preferably only for transferring the stored one).

At least the electrical contact for transferring the value of the operating parameter or identification code is directly connected to the electronic board.

The tool comprises an electronic control and command unit of the motor 55, operatively connected to the electric motor and to the battery, and configured to regulate the electric power supply of the electric motor M also based on the value of the operating parameter of the power supply battery (the one measured and/or the one stored in the memory of the electronic board) and/or based on the preset identification code.

For example, the electronic control and command unit 55 can be configured to limit the electrical power supply of the electric motor, so as to keep the power delivered, and thus absorbed, by the motor below a set value (by the electronic control and command unit 55 itself), based on the maximum power value deliverable by the battery and stored in the electronic memory of the electronic board.

In particular, the electronic control and command unit 55 can be configured to execute such a power supply limitation when the maximum power value deliverable by the battery and stored in the electronic board of the battery is less than a value of maximum power deliverable (absorbable) of the motor (such data can, for example, be stored in the electronic control and command unit 55 or can be read by the electronic control and command unit in an electronic memory of the motor M).

In further detail, when such a comparison detects that the maximum power deliverable (absorbed) by the motor is less with respect to that deliverable by the battery, the electronic control and command unit 55 may be configured to determine a maximum power value deliverable by the motor, based on the maximum power value deliverable by the battery, and to subsequently power the motor M while remaining below such a determined value, or it may be configured to power the motor so that the maximum power delivered (absorbed) by the motor is equal to the maximum power value deliverable by the battery.

Additionally, the electronic control and command unit 55 may also be configured not to entirely supply power to the motor if the maximum power value deliverable by the battery and stored in the electronic memory of the electronic board is below a preset minimum value (e.g., stored in the electronic control and command unit itself, i.e., in an electronic memory of the electronic control and command unit 55, or obtained from a difference between the maximum power deliverable by the motor and the maximum power deliverable by the battery).

As an alternative or in addition to the configurations of the electronic control and command unit of the motor indicated above, the electronic control and command unit of the motor may be configured to not electrically power the motor (i.e., to not allow an electrical power supply of the motor independently of drives executed by the tool user on the tool controls) if the preset identification code stored in the battery is different from a preset identification code, or from a preset group of identification codes, stored (written) in the electronic control and command unit of the motor (i.e., in a memory unit of the motor electronic control and command unit) according to the second communication protocol. In addition, the electronic control and command unit of the motor may be configured to enable the electrical power supply of the motor (i.e., the operator, acting on the tool, i.e., on the controls of the tool, can drive the motor of the tool) if the preset identification code stored in the battery corresponds to the preset identification code, or a preset group identification code, stored in the electronic control and command unit itself.

It is not excluded that in a further addition, should the electronic control and command unit detect a preset identification code stored in the battery which corresponds to an identification code that the electronic control and command unit of the motor has in its memory, but the value of the maximum power deliverable by the battery is not present, such a unit could be configured to allow the power supply of a predetermined maximum power stored in the unit itself.

It is not excluded that in a further addition, should the electronic control and command unit detect a preset identification code stored in the battery which corresponds to an identification code which the electronic control and command unit of the motor has in its memory, and further should the unit also detect the value of the maximum power deliverable by the battery stored in the battery, such a unit could be configured to allow the power supply of the motor at the predetermined maximum power read by the battery. It is not excluded that alternatively or additionally, the electronic control and command unit 55 may also be configured to vary the electrical power supply based on the measured temperature value, e.g., by limiting the power delivered by the motor M when the measured temperature is above a predetermined value.

The electronic control and command unit of the motor is configured according to a second communication protocol which is different from the first communication protocol. Thus, the electronic control and command unit 55 is configured to generate and send and/or to receive and process, (electrical and/or digital) signals encoded according to the second communication protocol, i.e., written in a second communication language.

As a consequence of this, if the electronic control and command unit 55 were to be connected to the electronic board 21 with a simple cable, i.e., to the connection interface 23, the electronic control and command unit 55 would not be capable of processing the data from the battery.

To solve such a problem, the tool comprises an electric connector 60,60′ which allows to translate/convert electrical/electronic signals (received from the battery) encoded according to the first communication protocol, into electrical/electronic signals encoded according to the second communication protocol (and send them to the electronic control and command unit 55).

The connector 60,60′ is galvanically (directly) interposed between the electronic control and command unit of the motor and the power supply battery, i.e., the electronic board 21, and directly fixed to the connection interface 23, in particular in a removable manner, e.g., by means of a release mechanism, preferably quick release.

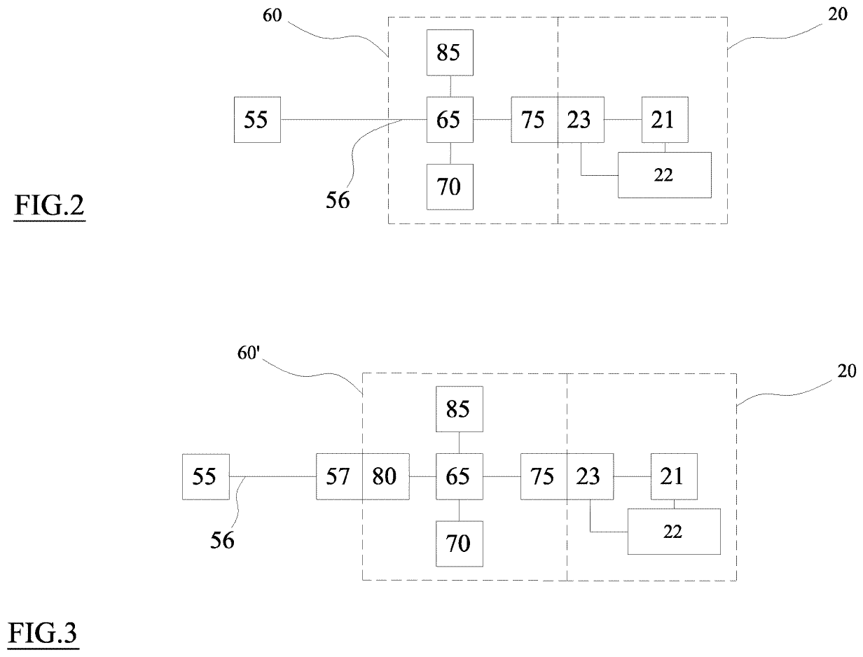

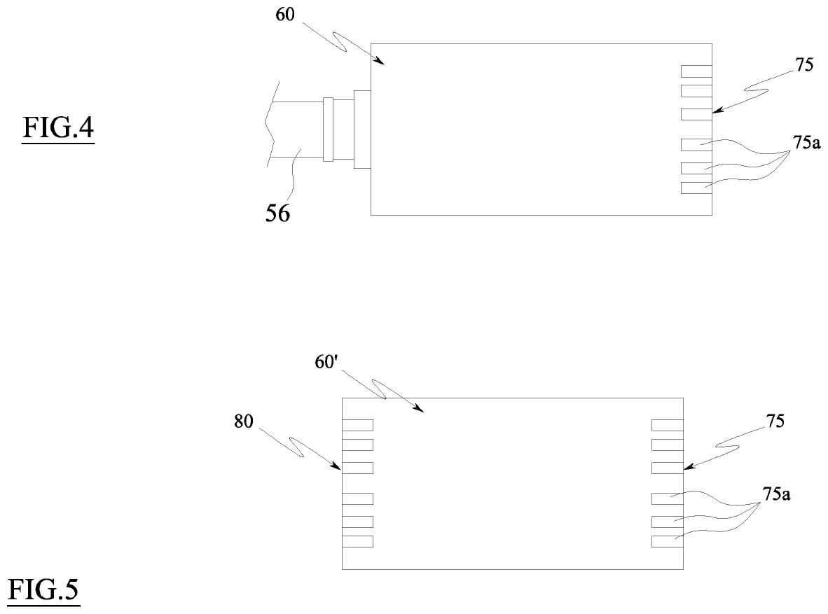

Furthermore, the connector 60,60′ comprises an electronic control and command unit 65 (i.e., a microprocessor), which is galvanically connected to the electronic control and command unit of the motor, for example by means of an electrical cable 56 starting from an electronic board of the electronic control and command unit 55 and ending in the connector 60 itself (FIGS. 2 and 4) or in a connector 57 (FIGS. 3 and 5), which is purely mechanical, i.e., without an electronic control and command unit but capable of establishing a galvanic connection between two elements (e.g., by means of electrical contacts), to which the connector 60′ is directly connected, i.e., a second possible connection interface thereof, as will be described below.

Further, the connector comprises an electronic memory 70, which is galvanically connected to the control and command electronic unit 65 of the connector 60,60′ and in which a computer code (i.e., a set of instructions) is stored, which computer code, when executed by the electronic control and command unit 65, translates/converts signals, encoded in the first communication protocol, received from the electronic board 21 of the battery, into signals encoded in the second communication protocol (and sends such translated/converted signals to the electronic control and command unit 55).

The electronic control and command unit 55 is thus configured to regulate the power supply of the electric motor M also or at least based on a signal received from the connector 60,60′ in the first communication protocol and converted or translated into the second communication protocol by the electronic control and command unit 65.

It follows that all of the above-described configurations of the electronic control and command unit which arise from the value of the maximum power deliverable by the battery and stored in the battery itself, are applied to a signal, converted from the first communication protocol into the second communication protocol, containing the value of the maximum power deliverable by the battery, which is stored in the battery encoded in the first communication protocol.

For example, the electronic control and command unit 55 may be configured to limit the electrical power supply of the electric motor, so as to keep the power delivered (absorbed) by the motor M below an established value (by the electronic control and command unit 55 itself, e.g., calculated, or preset, or substantially equal to the maximum power value deliverable by the battery), based on the signal, converted in the second communication protocol, of the maximum power value deliverable by the battery.

The electronic control and command unit 65 could be configured to send a signal requesting the value of the operating parameter in the electronic memory 21a to the electronic board of the battery, e.g., as soon as the electronic control and command unit 65 is electrically powered by the connection with the battery. The electronic board can thus be configured to, in response to such a signal, send such a value to the electronic control and command unit 65. Equivalently, the electronic board can itself be configured to detect the connection to the connector 60,60′ and to directly send the stored value. A further alternative is that the electronic control and command unit 65 can be configured to directly read the electronic memory 21a and thus the value stored therein itself.

Similarly, all of the above-described configurations of the electronic control and command unit arising from the identification code stored in the battery itself, apply to a signal, converted from the first communication protocol into the second communication protocol, containing the identification code, which is stored in the battery encoded in the first communication protocol.

For example, the electronic control and command unit 55 may be configured not to supply power to the electric motor when the identification code converted in the second communication protocol does not correspond to the preset identification code, or at least one of the preset identification code(s) of the group, which preset identification code(s) is (are) encoded in the second communication protocol.

The electronic control and command unit 65 could be configured to send a request signal to the electronic board of the battery of the identification code present in the electronic memory 21a, e.g., as soon as the electronic control and command unit 65 is electrically powered by the connection with the battery. The electronic board can thus be configured to, in response to such a signal, send such an identification code to the electronic control and command unit 65. Equivalently, the electronic board can itself be configured to detect the connection to the connector 60,60′ and to send the identification code directly. A further alternative is that the electronic control and command unit 65 can be configured to directly read the electronic memory 21a and thus the stored identification code itself. Similarly, all of the above-described configurations of the electronic control and command unit which result from the measured temperature value, are applied to a signal, converted from the first communication protocol into the second communication protocol, containing the measured temperature value, which is measured and sent in the first communication protocol, from the electronic board to the connector.

The connector 60,60′ may comprise a connection interface 75 by means of which it is galvanically connected to the battery. In particular, such a connection interface 75 comprises at least one electrical contact galvanically connected to the electronic board of the battery, i.e., to the connection interface 23, e.g., comprises one electrical contact 75a for each electrical contact on the connection interface 23 (and such a corresponding electrical contact is configured to execute the same function as the corresponding contact on the interface 23).

The connection interface 75 comprises the plurality of electrical contacts 75a and a guide body which engages with the guide body of the connection interface 23.

The connection interface 75 thus forms a plug and play connection with the connection interface 75.

For the connection to the electronic control and command unit 55, the connector may comprise, in the case of the connector 60, an electrical cable 56 directly (and galvanically) connected to the electronic control and command unit 65, or, in the case of the connector 60′, a second connection interface 80, substantially shaped like the first connection interface 75 and adapted to form a plug and play connection with another connection interface which is connected to the electronic control and command unit 55, for example with the connector 57 at the end of the cable which is derived from the electronic control and command unit 55. Such a second connection interface 80 is directly (and galvanically) connected to the electronic control and command unit 65.

The connector may comprise a transceiver 85, e.g., Bluetooth or wifi, operatively connected to the electronic control and command unit 65.

In such a case, the electronic control and command unit 65 can be configured to wire-lessly connect the tool to a remote device provided with a transceiver compatible with the transceiver 85.

For example, the electronic control and command unit 65 can be configured to send the battery voltage value and/or the battery temperature value and/or the maximum power value deliverable by the battery 20 and/or the preset identification code to the remote device by means of the transceiver. All these parameters are read by the electronic control and command unit 65 by means of the connection of the electrical contacts of the connector 60,60′ to the corresponding electrical contacts of the battery.

Further, the electronic control and command unit 65 can be configured to send values of operating parameters of the motor, such rpm of the motor and/or hours of use to the remote device by means of the transceiver, which the electronic control and command unit 65 reads by means of the connection with the electronic control and command unit 55.

Since the values of the operating parameters of the motor are encoded according to the second communication protocol and the parameter values measured or stored in the battery are encoded according to the first communication protocol, the electronic control and command unit 65 can be configured to translate the signals it receives from the battery and motor into a communication protocol of the remote device.

In particular, the remote device could be configured according to the first communication protocol or according to the second communication protocol, or according to a third different communication protocol.

In the first case, the computer code, when executed by the electronic control and command unit 65, directly sends signals encoded in the first communication protocol from the battery to the remote device and translates/converts signals, encoded in the second communication protocol, received from the electronic control and command unit 55, into signals encoded in the first communication protocol and sends them to the remote device. In the second case, the computer code, when executed by the electronic control and command unit 65, directly sends signals encoded in the second communication protocol from the electronic control and command unit 55 to the remote device and translates/converts signals, encoded in the first communication protocol, received from the battery, into signals encoded in the second communication protocol and sends them to the remote device.

In the third case, the computer code, when executed by the electronic control and command unit 65 translates/converts both signals encoded in the first communication protocol, received from the battery, into signals encoded in the third communication protocol and sends them to the remote device, and signals encoded in the second communication protocol, received from the electronic control and command unit 55, into signals encoded in the third communication protocol and sends them to the remote device.

The invention thus also provides a landscaping apparatus provided with the tool and the remote device provided with the transceiver, preferably the remote device also comprises display means adapted to allow the display (in the sense of being intelligible to a user) of the values received from the receiver of the connector.

The connector 60,60′ comprises a box-like, e.g., made of polymer material, inside which the electronic control and command unit 65 and the electronic memory 70 are contained.

The connection interface 75 crosses a wall of such a box-like enclosure, so that it can be accessed from the outside, in particular so that it can be connected to the connection interface 23 of the battery 20.

If present, the second connection interface 80 also crosses a wall of this such a box-like enclosure, so as to be accessible from the outside, in particular so that it can be connected to the electronic control and command unit 55, i.e., to the connector 57 of the cable 56 derived therefrom.

The tool may comprise means for coupling the battery to the tool (not illustrated) made in a portion of the tool casing, and the connector 60,60′ is positioned at said means, such that when the battery is coupled by means of the coupling means, the connection interface 23 is engaged in the connector 60,60′, i.e., in the connection interface 75.

In the embodiment illustrated, the tool comprises a battery compartment, into which the battery is inserted, e.g., guided by a guide (not illustrated).

At such a compartment, e.g., therein, the connector 60,60′, preferably with the connection interface 75 crossing an inner wall of the compartment, and possibly the battery coupling means, are positioned.

The tool may comprise a manual command interface for driving and/or regulating (settings of) the tool, e.g., directly associated with the casing 15 or the frame (so as to protrude at least partially outside said frame or casing, so as to be driven by an operator). The manual command interface comprises buttons and/or levers and/or knobs and/or a slider and/or a lever and/or a proximity sensor which at least allow the tool to be switched on and off and the cutting element to be driven (once the tool is switched on).

The manual command interface may comprise, for example, a first manual command element 30 adapted to command the switching on and off of the tool.

The first command element can thus be movable (moving with respect to the casing) between a first position corresponding to switching the tool on and a second position corresponding to switching the tool off.

In addition, the manual command interface may comprise a second manual command element 35, adapted to command (regulate) a movement of the movable working element, e.g., by commanding (regulating) the motor torque delivered by the motor. Such a second element can thus be said to regulate a movement (rotation) speed of the working element by means of its driving.

The second manual command element 35 is also movable between a first position and a second position, where the first position corresponds to a request for no movement of the working element (i.e., no motor drive) and the second position corresponds to a request for movement at maximum speed (i.e., a request for motor drive at the maximum power deliverable).

Further, the manual command interface may comprise a third manual command element 40, adapted to allow the regulation of one or more tool parameters, such as a maximum torque delivered by the motor, i.e., a maximum (rotation) speed of the working element.

The manual command interface may comprise a fourth manual command element 45, adapted to allow to enable the second manual command element 35. Such a fourth element is a safety element, preferably implemented as a lever, which must be driven for the second command element to be electrically or mechanically enabled. For example in the figures, the fourth element is positioned in the handle near the second command element, e.g., on a side of the handle which is diametrically opposite the side in which the second command element is positioned. In particular, the fourth element illustrated is known as the palm lever.

The electronic control and command unit 55 is operatively connected to the first manual command element and is configured to bring the tool from a condition in which it is switched off to a condition in which it is switched on (enabled) based on the receipt of a command given (at least) by means of said element. In particular, when the first manual command element is in the second position, the electronic control and command unit 55 is configured to interrupt the supply of energy (e.g., electrical) to the tool motor, while when the first manual command element is in the first position, the electronic control and command unit 55 is enabled to allow the energy supply (e.g., electrical) to the tool motor. Apart from cases of tools of the on-off type, i.e., in which the movable working element can only be either stationary or moving at a predetermined speed, and in which when the first command element is in the first position the movable working element is immediately set in motion, in other cases the tool comprises the second manual command element, which is operatively connected to the electronic control and command unit, e.g., galvanically, and the electronic control and command unit is configured to vary the motor torque delivered by the tool motor (acting on the motor power supply) based on a signal given by the user by means of the second command element. For example, the second command element can normally be in the first position (preferably due to the force exerted thereon by an elastic element) and the user can apply a force on said second command element to bring it towards the second position. The closer the second command element is to the second position, the more the electronic control and command apparatus increases the (electrical) power supply to the motor to increase the speed of the moving work element.

When the second command element is in the second position, the electronic control and command unit 55 powers the motor to deliver maximum power, which is determined in the modes described above based on the value of the maximum deliverable power of the battery.

Similarly, in the case of tools of the on-off type, when the first command element is in the second position, the electronic control and command unit 55 powers the motor to deliver maximum power, which is determined in the modes described above based on the value of the maximum deliverable power of the battery.

As an alternative or in addition to the above-described relationship between the command elements and the electronic control and command unit with reference to when the value of the operating parameter is the value of the maximum power deliverable by the battery, if the electronic control and command unit detects that the preset battery identification code stored in the battery does not correspond to the preset code, or at least one preset group code, stored in the unit itself, whatever the position of the second command element (or of the first command element only if the second command element is not present), the electronic control and command unit is configured not to electrically power the motor.

In addition, when the electronic control and command unit detects that the preset identification code stored in the battery corresponds to the preset code, or at least one preset group code, stored in the unit itself, the electronic control and command unit is configured to electrically power the motor in accordance with the position of the second command element (or only the first command element if the second command element is not present). Further, in the latter case, if the electronic control and command unit has also processed the maximum power value deliverable by the battery, the electronic control and command unit is configured to electrically power the motor in accordance with the position of the second command element (or only the first command element if the second command element is not present) and the maximum power deliverable, so that in the second position of the command element the electric motor is powered at the maximum power deliverable by the battery.

The invention thus conceived is susceptible to several modifications and variations, all falling within the scope of the inventive concept.

Moreover, all details can be replaced by other technically equivalent elements.

In practice, the materials used, as well as the contingent shapes and sizes, can be whatever according to the requirements without for this reason departing from the scope of protection of the following claims.

1. A battery-powered electric landscaping tool, comprising:
an electric motor,
a power supply battery of the electric motor, which power supply battery is provided with an electronic board configured to allow the monitoring of at least one value of an operating parameter of the power supply battery and/or in which a value of an operating parameter of the power supply battery is stored and/or a preset identification code of the battery is stored, said electronic board being configured to communicate said value, or said values, and/or said preset identification code, according to a first communication protocol,
an electronic control and command unit of the electric motor operatively connected to the electric motor and the battery, and configured to regulate the electric motor's power supply also based on the value of the operating parameter of the supply battery, or based on the value of the monitored operating parameter and the value of the stored operating parameter, and/or the preset identification code, said electronic control and command unit of the motor being configured according to a second communication protocol different from the first communication protocol, and
an electrical connector galvanically interposed between the electronic control and command unit of the motor and the power supply battery, and to which a connection interface of the battery is connected,
wherein the connector comprises an electronic control and command unit, which is galvanically connected to the electronic control and command unit of the motor, and an electronic memory which is galvanically connected to the electronic control and command unit of the connector itself,
wherein a computer code is stored in the electronic memory, which, when executed by the electronic control and command unit, translates signals in the first communication protocol received from the electronic board of the battery, into signals in the second communication protocol and sends them to the electronic control and command unit of the motor.

2. The tool according to claim 1, wherein the connector comprises a wireless transceiver.

3. The tool according to claim 1, comprising means for coupling the battery to the tool, and wherein the connector is positioned at said means, such that when the battery is coupled by means of the coupling means, the connector is connected to the battery.

4. The tool according to claim 1, wherein the stored operating parameter of the battery is the maximum power deliverable being the maximum discharge value, and wherein the electronic control and command unit of the motor is configured to limit the maximum power of the motor based on the stored value of said operating parameter.

5. The tool according to claim 1, wherein the connector comprises a connection interface by means of which it is galvanically connected to the battery, wherein the connection interface comprises at least one electrical contact galvanically connected to the electronic board of the battery.

6. The tool according to claim 1, wherein the electronic control and command unit of the motor is configured not to electrically power the motor if the preset identification code stored in the battery is different from a preset identification code, or a preset group of identification codes, stored in the electronic control and command unit of the motor.

7. An electrical connector for a battery-powered landscaping tool, said electrical connector comprising:
a first connection interface adapted to allow a removable galvanic connection with an electric battery to power the landscaping tool,
an electrical cable, or a second connection interface, adapted to allow a galvanic connection to an electronic control and command unit of the landscaping tool,
an electronic control and command unit galvanically connected to the first interface and to the second interface or to the electrical cable, and
an electronic memory, which is galvanically connected to the electronic control and command unit of the connector itself,
wherein a computer code is stored in the electronic memory, which, when executed by the electronic control and command unit, translates signals received by means of the first communication interface and encoded according to a first communication protocol, into corresponding signals encoded in a second, different communication protocol and sends them to the electronic control and command unit of the motor after such a translation.

8. The electrical connector according to claim 1, comprising a boxlike body provided with the first connection interface and the second connection interface, positioned so as to be accessible from outside the box-like body itself, and wherein the electronic control and command unit is positioned inside the box-like body.
